(19) United States
(12) Patent Application Publication
(10) Pub. No.: US 2016/0354737 A1
(43) Pub. Date: Dec. 8, 2016

(54) HYDRATION APPARATUS AND METHOD

(71) Applicant: SCHLUMBERGER TECHNOLOGY CORPORATION, Sugar Land, TX (US)

(72) Inventors: Christopher Joseph Decker, Richmond, TX (US); Jonathan Wun Shiung Chong, Sugar Land, TX (US); Rajesh Luharuka, Katy, TX (US); Avinash Ramesh, Houston, TX (US); William Bradford Stone, Pearland, TX (US)

(21) Appl. No.: 14/731,680

(22) Filed: Jun. 5, 2015

(51) Int. Cl. B01F 5/06; B01F 3/08

(52) U.S. Cl. CPC B01F 5/0602; B01F 3/0861

(57) ABSTRACT

An apparatus is disclosed including a cylindrical vessel including an inside wall defining an interior volume, a first vessel end and a second vessel end, a top and a bottom; at least one inlet in the bottom of the cylindrical vessel; at least one and at most one outlet in the top of the cylindrical vessel; and at least one dividing plate attached to the inside wall and disposed within the interior volume. A method for hydrating a polymer is also disclosed utilizing such apparatus and including: a. introducing a slurry comprising water and the polymer to the cylindrical vessel through the inlet; and b. removing an at least partially hydrated polymer slurry from the outlet of the cylindrical vessel.

### FIELD

The disclosure generally relates to the preparation of subterranean formation treatment fluids, and more particularly, but not by way of limitation, apparatus and methods for preparing treatment fluids from a mixture including, in some cases, a hydratable material and water.

### BACKGROUND

The statements in this section merely provide background information related to the disclosure and may not constitute prior art.

In the oil and gas drilling and production industry, viscous aqueous fluids are commonly used in treating subterranean wells, as well as carrier fluids. Such fluids may be used as fracturing fluids, acidizing fluids, and high-density completion fluids. In an operation known as well fracturing, such fluids are used to initiate and propagate underground fractures for increasing petroleum productivity.

Viscous fluids, such as gels, are typically an aqueous solution of a polymer material. A common continuous method used to prepare viscous fluids at a wellbore site, involves the use of initial slurry of the polymer material in a hydrocarbon carrier fluid (i.e. diesel fluid) which facilitates the polymer dispersion and slurry mixing. Although this process achieves the required gel quality, the presence of hydrocarbon fluids is often objected to in particular fields, even though the hydrocarbon represents a relatively small amount of the total fracturing gel once mixed with water. Also, there are environmental problems associated with the clean-up and disposal of both hydrocarbon-based concentrates and well treatment gels containing hydrocarbons; as well as with the clean-up of the tanks, piping, and other handling equipment which have been contaminated by the hydrocarbon-based gel.

Other applications used for the continuous mixing of viscous treatment gels include gelling the polymer in a hydrocarbon carrier that is mixed with water to produce the fracturing gel which is then flowed through vertically baffled tanks providing first-in/first-out (FIFO) flow pattern, and allowing for the hydration time of the gel.

Some hydration tanks configured in a first-in/first-out configuration are vented tanks which operate by use of gravity to flow a hydrating gel, formed of a polymeric viscosifier in aqueous solution, through the tank. As the polymer concentration in the gel increases, viscosity increases, and gravity flow of the gel is only possible up to a practical polymer concentration. As a result such systems are not useful to handle hydration of gels having a high concentration of viscosifier.

Therefore, there is a need for apparatus and methods useful for hydrating constituents at high concentrations to prepare viscous treatment gels in a continuous mode, without the use of hydrocarbon carriers, and with decreased equipment size and space requirements, such need met, at least in part, by the following disclosure.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

In an embodiment, an apparatus is disclosed which includes a cylindrical vessel having an inside wall defining an interior volume, a first vessel end and a second vessel end, a top and a bottom; at least one inlet in the bottom of the cylindrical vessel; at least one and at most one outlet in the top of the cylindrical vessel; and at least one dividing plate attached to the inside wall and disposed within the interior volume.

In accordance with another embodiment, an apparatus is disclosed including: a plurality of cylindrical vessels comprising n cylindrical vessels in series, wherein n is at least 2, and each of the plurality of cylindrical vessels includes:
an inside wall defining an interior volume, a first vessel end and a second vessel end, a top and a bottom;
at least one and at most one inlet in the bottom of the cylindrical vessel;
at least one and at most one outlet in the top of the cylindrical vessel;
at least one dividing plate attached to the inside wall and disposed within the interior volume; and
   wherein, for the 2nd and any subsequent cylindrical vessel, the inlet of the nth cylindrical vessel is connected in fluid flow communication with the outlet of the n−1 cylindrical vessel.

In accordance with another embodiment, a method for hydrating a polymer is disclosed and includes:

utilizing an apparatus comprising:
a cylindrical vessel comprising an inside wall defining an interior volume, a first vessel end and a second vessel end, a top and a bottom;
at least one inlet in the bottom of the cylindrical vessel;
at least one outlet in the top of the cylindrical vessel;
at least one dividing plate attached to the inside wall and disposed within the interior volume;
   introducing a slurry including water and the polymer to the cylindrical vessel through the inlet; and
   removing an at least partially hydrated polymer slurry from the outlet of the cylindrical vessel.

In accordance with another embodiment, a method for hydrating a polymer is disclosed using an apparatus including a plurality of n cylindrical vessels in series, each including at least one and at most one inlet and at least one and at most one outlet; n is at least 2; and for the 2nd and any subsequent of the cylindrical vessels, the inlet of the nth cylindrical vessel is connected in fluid flow communication with the outlet of the n−1 cylindrical vessel; and

introducing a slurry including water and the polymer to a first cylindrical vessel through the inlet;
removing an at least partially hydrated polymer slurry from the outlet of the first cylindrical vessel;
for the 2nd and any subsequent of the cylindrical vessels:
introducing an at least partially hydrated polymer slurry to the inlet of the nth cylindrical vessel; and
removing the at least partially hydrated polymer slurry from the outlet of the nth cylindrical vessel.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein.

FIG. 1A illustrates some apparatus embodiments in accordance with the disclosure.

FIG. 1B shows a top plan view of the apparatus of FIG. 1A.

FIG. 1C shows a cross section view of the apparatus of FIG. 1B along section 1C-1C.

FIG. 1D shows a cross section view of the apparatus of FIG. 1A along section 1D-1D.

FIG. 1E shows a cross section view of the apparatus of FIG. 1B along section 1E-1E.

FIG. 1F shows a cross section view of the apparatus of FIG. 1B along section 1E-1E.

FIG. 2A illustrates some apparatus embodiments in accordance with the disclosure.

FIG. 2B shows a top plan view of the apparatus of FIG. 2A.

FIG. 2C shows a cross section view of the apparatus of FIG. 2B along section 2C-2C.

FIG. 3A illustrates a plan view of some apparatus embodiments in accordance with the disclosure.

FIG. 3B illustrates some apparatus embodiments in accordance with the disclosure.

FIG. 3C shows a top plan view of an outlet slotted flange in accordance with the disclosure.

FIG. 3D shows an end plan view of the apparatus of FIG. 3B in accordance with the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Finally, as used herein any references to “one embodiment” or “an embodiment” means that a particular element, feature, structure, or characteristic described in connection with the embodiment is included in at least one embodiment. The appearances of the phrase “in one embodiment” or “in accordance with an embodiment” in various places in the specification are not necessarily referring to the same embodiment.

As used herein the term “vessel” means a volume of space surrounded by outer surfaces or walls of an apparatus, and is inclusive of such outer surfaces or walls. The term “interior volume” herein means a volume of space defined within outer surfaces of an apparatus.

Some aspects of the disclosure relate to apparatus for, and methods of, forming a solvated mixture, or suspension, of a solids portion and a liquid medium by increasing residence time of the mixture within the apparatus. Some other aspects relate to apparatus for, and methods of, forming a product of a chemical contained in a liquid component and a second component through increasing residence time of the admixture within the apparatus. Some other aspects relate to hydration of hydratable material by increasing residence time of a mixture of water and hydratable material within a hydration apparatus. The hydratable material may be a solid material, or other chemical, which is hydratable in an aqueous liquid, or even slurry of a hydratable material, which is mixed with the aqueous liquid portion. Some non-limiting examples of hydratable material include viscosifying polymers, friction reducers, viscoelastic surfactants, cement components, drilling fluid constituents, and the like. Some other aspects of the disclosure relate to apparatus and methods involving a flow of mixture of chemicals undergoing a rate limited chemical process, or reaction, requiring residence time with the help of a motive force such as pressure. The apparatus of the disclosure, as well as use thereof, are useful in preparing a fluid from a mixture containing one or more materials which may react in any way, including association, such as surfactant, polymer or solids separation and association with water in hydration, or even chemical reaction to form another material through ionic or covalent bonding. As such, apparatus of the disclosure may be referred to as hydration or reaction vessels. The apparatus and methods may also be applied where a first-in/first-out (FIFO) process is used where different chemicals are introduced in sequence, and where time for a chemical reaction to complete, or substantially complete, is allowed before a second chemical is added to the flow.

Residence time within the apparatus (mix system) may be improved, or extended, by directing the fluid mixtures through the apparatus via one or a plurality of chambers, or passageways, formed within a cylindrical vessel or cylindrical vessel(s). In some aspects, the directing of the mixture may be accomplished by passing the mixture through a continuous channel or passageway which has a length greater than a distance between the perimeter and center of a cylindrical vessel, or even a length greater than the outer perimeter of the cylindrical vessel, or interior volume of the cylindrical vessel.

The channel or passageway, or plurality of channels or passageways, are fluidly connected with an inlet and outlet of the apparatus. A mixture may be introduced into the apparatus, flow in a nonlinear pattern through the apparatus, and subsequently discharge in a greater hydrated, solvated or suspended state. The figures and description only depict how some embodiments may be enabled and function in a practical sense within the spirit of the concept of disclosure, and the concept is not solely limited to the embodiments described.

In some embodiments of the disclosure, preparation of subterranean formation treatment fluids, and more particularly, but not by way of limitation, apparatus and methods for preparing a viscous gel from essentially dry hydratable polymer constituents and water in a continuous mode are described. In some cases, the apparatus and methods are useful for preparing a viscous hydrated gel from dry polymer at a wellbore site for fracturing a subterranean formation. Some embodiments of the disclosure relate to first-in/first-out gel hydration vessels which provide effective polymer hydration by forcing a hydratable polymer and fluid mixture to sweep a significant volume of a hydration vessel. The volumetric capacity may be determined by the desired polymer concentration, the required hydration time for the polymer concentration, and the desired rate of hydrated polymer slurry production. In some aspects, the cylindrical vessel design may be a pressure vessel design comprised of a series of flanged cylindrical vessels each having at least one dividing plate.

As used herein: the term “gel” means any liquid material in a viscous state suitable for any number of applications known in the art, including, but not limited to, treating a wellbore; “dry polymer”, “hydratable polymer”, “hydratable material” may mean, in some cases, any form of polymer material which is commercially available, transferred, or supplied, in a solid, slurried and/or coated form (crystalline, amorphous, or otherwise), and not necessarily in an aqueous or non-aqueous solution or slurry, and may be any polymer type useful for well treatments, including, but not limited to, guar gums, which are high-molecular weight polysaccharides composed of mannose and galactose sugars, or guar derivatives such as hydroxypropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form. Xanthan, diutan, and scleroglucan, three biopolymers, may also be useful as polymers in accordance with the disclosure. Synthetic polymers such as, but not limited to, polyacrylamide and polyacrylate polymers and copolymers, used typically for high-temperature and/or friction reduction applications, may also be used. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups. Any dry polymer may contain commercially acceptable moisture levels, or have a coating or pre-treatment. The term “gel” may also mean a slurry of partial or fully hydrated polymer in water. Hydratable material may also include other types of viscosifying agents, such as viscoelastic surfactants, or silicates, for example.

In some aspects of the disclosure, the liquid portion of a mixture may be an aqueous medium which can include, for example, produced water, fresh water, seawater, brine or a combination thereof. In embodiments in which the aqueous medium includes brine, the brine can be, for example, water including an inorganic salt, organic salt or a combination thereof. Suitable inorganic salts can include alkali metal halides such as potassium chloride. The brine phase can include an organic salt such as sodium or potassium formate, or sodium or potassium salicylate. Suitable inorganic divalent salts can include calcium halides such as calcium chloride, calcium bromide or a combination thereof. Sodium bromide, potassium bromide, or cesium bromide can be used, either alone or in combination. The salt can be chosen for compatibility reasons.

Further, as used herein, the term “slurry” or “slurries” means any fluid mixture of the respective hydratable material with a liquid, which may flow under low shear condition and is also capable of being pumped under pressure. Generally, to form the slurry, a mixture of the hydratable material and liquid are introduced into apparatus according to the disclosure, subject to a suitable hydration residence time with the apparatus, and discharged from the apparatus where the hydratable material is at least partially hydrated. The unique interior design features of the apparatus enable significantly improved hydration effectiveness compared to traditional hydration tanks with like volumetric space.

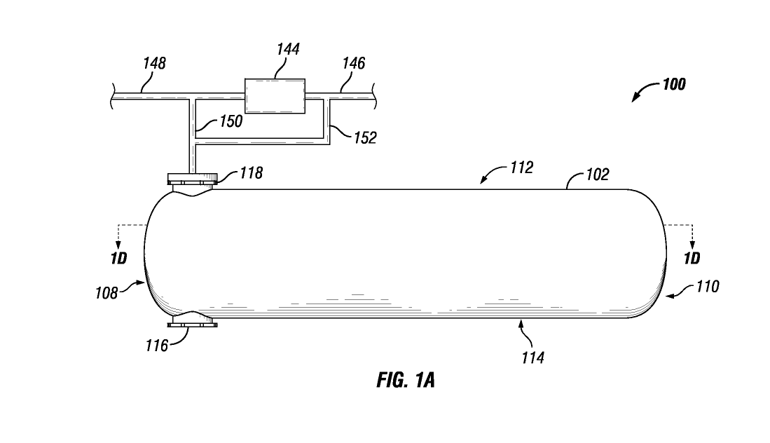

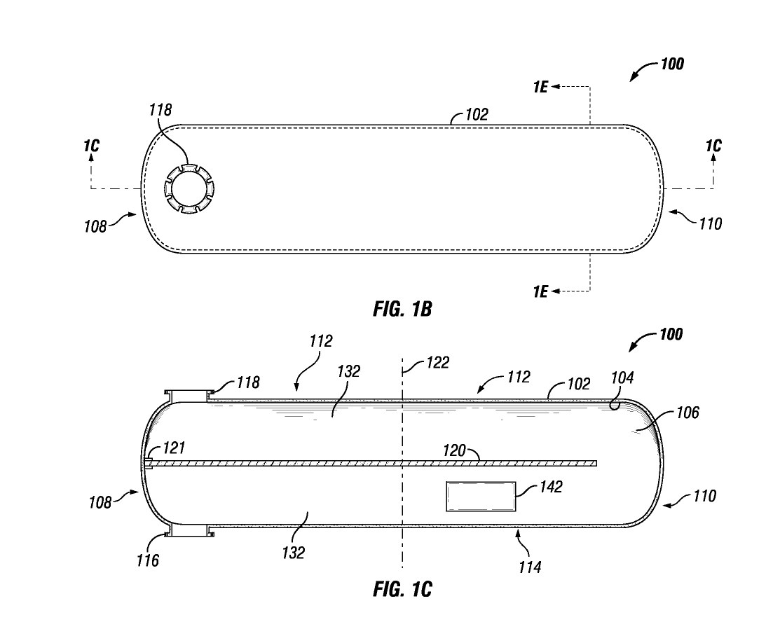

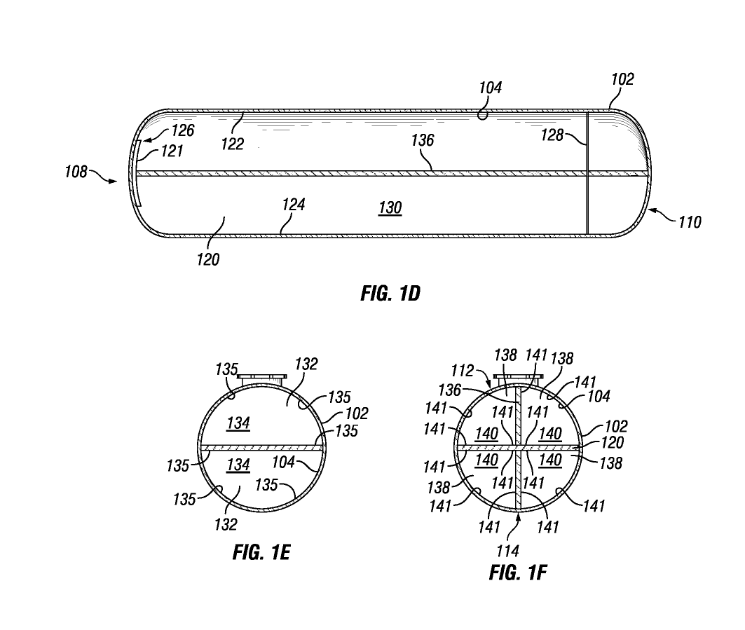

Now referring generally to FIGS. 1A-1C, which illustrates some apparatus embodiments according to the disclosure, FIG. 1A is a side plan view showing an apparatus 100 useful, among other things as described herein, for hydrating a mixture of water and a hydratable material, such as hydratable polymers used to viscosify and/or reduce the turbulent flow properties of a subterranean formation treatment fluid. FIG. 1B shows apparatus 100 in top view, and FIG. 1C shows a cross sectional view of apparatus 100 along section 1C-1C from FIG. 1B. FIG. 1D shows a cross section view of apparatus 100 along section 1D-1D shown in FIG. 1A. With reference to FIGS. 1A-1D, Apparatus 100, which may be a mix system for at least partially hydrating, or enabling a chemical reaction, can comprise, consist of, or consist essentially of:
a. a cylindrical vessel 102 comprising an inside wall 104 defining an interior volume 106, a first vessel end 108 and a second vessel end 110, a top 112 and a bottom 114;
b. at least one inlet 116 in the bottom of the cylindrical vessel 102;
c. at least one and at most one outlet 118 in the top 112 of the cylindrical vessel 102; and
d. at least one dividing plate 120 attached to the inside wall 104 and disposed within the interior volume 106.

In accordance with an embodiment, cylindrical vessel 102 has a vertical cylindrical vessel axis 122 (shown in FIG. 1C) extending from the bottom to the top; wherein (as shown in FIG. 1D) the at least one dividing plate 120 comprises a first side 122, a second side 124, a first dividing plate end 126, a second dividing plate end 128, and a dividing plate surface 130 extending from the first side 122 to the second side 124; and wherein the first side 122 and the second side 124 are connected to the inside wall 104 of the cylindrical vessel 102, the first dividing plate end 126 is connected to the inside wall 104 of the cylindrical vessel 102 at either the first vessel end 108 or the second vessel end 110 (shown attached to the first vessel end 108 in FIGS. 1C and 1D), and the dividing plate surface 130 is substantially perpendicular to the vertical cylindrical vessel axis 122. The at least one dividing plate 120 can be attached directly to inside wall 104, or can each be positioned within divider plate channel(s) 121 attached to inside wall 104.

The cylindrical vessel 102 can comprise an odd number of the at least one dividing plates 120 (as shown in FIGS. 1A-1D), and the at least one inlet 116 can be located near the first vessel end 108 or the second vessel end 110 (shown as the first vessel end 108 in FIGS. 1A-1C) and the at least one and at most one outlet 118 can be located near the same of the first vessel end 108 and second vessel end 110 that the at least one inlet 116 is located near.

The first dividing plate ends 126 of the at least one dividing plates 120 are connected to the cylindrical vessel 100 alternatingly between the first vessel end 108 and the second vessel end 110.

The at least one dividing plate 120 and the inside wall 104 can form a plurality of channels 132 each having a channel cross sectional area 134 (shown in FIG. 1E which shows a cross section view of apparatus 100 along section E-E shown in FIG. 1B) and a hydraulic diameter HD such that the ratio of the HD to the maximum HD is greater than about 0.1 and less than or equal to about 1 or from about 0.25 to about 1 or from about 0.5 to about 1, wherein HD equals 4 times the channel cross sectional area 134 divided by the wetted perimeter 135 of the channel, and wherein the maximum HD is the HD of a circular channel formed by a circular pipe with a cross-sectional area equal to the channel cross sectional area 134.

In accordance with an embodiment, and with reference to FIG. 1F (which shows an alternate cross section view of apparatus 100 similar to that of FIG. 1E and also along section E-E shown in FIG. 1B), the cylindrical vessel 102 can comprise at least one partition 136 positioned substantially perpendicular to the at least one dividing plate 120 and extending along the length of the cylindrical vessel 102, as shown in FIG. 1D. The at least one partition 136 can be attached to the inside wall 104 at the top 112, the bottom 114, the first vessel end 108 and the second vessel end 110. The at least one dividing plate 120, the inside wall 104 and the at least one partition 136 form a plurality of partitioned channels 138 each having a partitioned channel cross sectional area 140 and a hydraulic diameter HD such that the ratio of the HD to the maximum HD is greater than about 0.1 and less than or equal to about 1.0 or from about 0.25 to about 1 or from about 0.5 to about 1, wherein HD equals 4 times the channel cross sectional area 140 divided by the wetted perimeter 141 of the channel, and wherein the maximum HD is the HD of a circular channel formed by a circular pipe with a cross-sectional area equal to the channel cross sectional area 140.

The cylindrical vessel 102 can comprise a mixing element 142 in the interior volume, as shown in FIG. 1C. Mixing element 142 can be selected from, but is not limited to, a static mixer, a rotating inline blade or any type of rotor. Additional mixing can also be introduced through non-contact energy introduction such as ultrasound. The cylindrical vessel can be made of a material selected from the group consisting of metal, glass reinforced plastic, and combinations thereof. With reference to FIG. 1A, the apparatus can comprise a dilution pump 144 having a pump inlet 146 and a pump outlet 148, and a cylindrical vessel outlet pipe 150 connected in fluid flow communication with the at least one and at most one outlet 118 of the cylindrical vessel 102 and the pump outlet 148. A diversion pipe 152 can also be connected in fluid flow communication with the cylindrical vessel outlet pipe 150 and the pump inlet 146 for diversion of fluid from the outlet 118 of the cylindrical vessel 102 to the pump inlet 146.

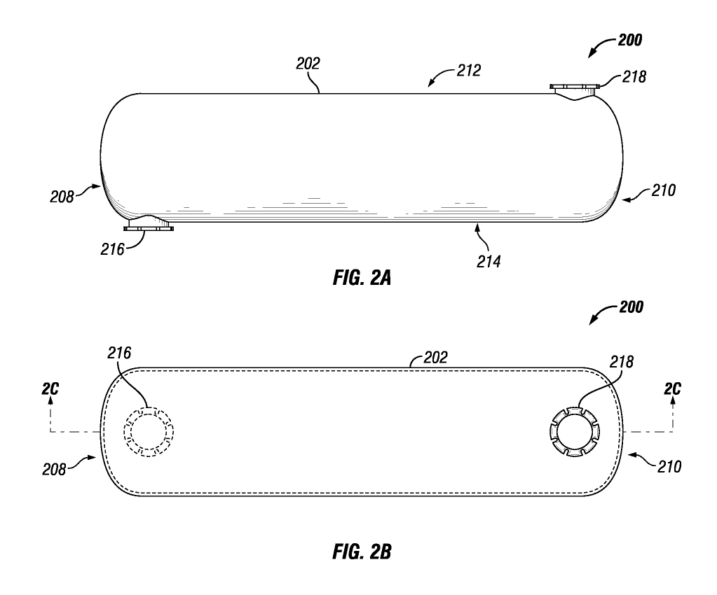

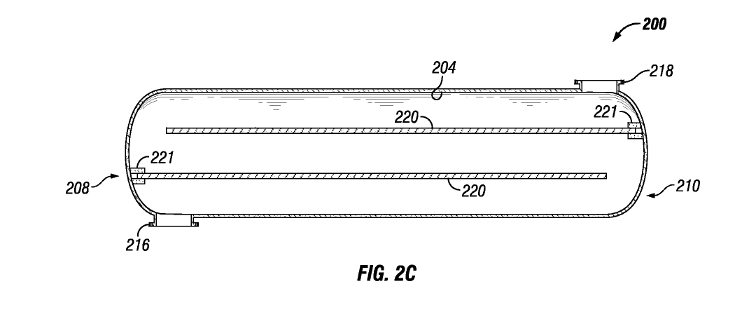

With reference to FIGS. 2A-2C, and in accordance with another embodiment, FIG. 2A shows an apparatus 200 including a cylindrical vessel 202. Any of the above embodiments and elements described above for apparatus 100 can also apply with regard to apparatus 200. FIG. 2B shows apparatus 200 in top view, and FIG. 2C shows a cross sectional view of apparatus 200 along section 2C-2C from FIG. 2B. Cylindrical vessel 200 can comprise an even number of at least two dividing plates 220, a top 212, a bottom 214, and an at least one inlet 216 can be located near a first vessel end 208 or a second vessel end 210 (shown as the first vessel end 208 in FIGS. 2A-2C) and an at least one and at most one outlet 218 can be located near the opposite of the first vessel end 208 or second vessel end 210 that the at least one inlet 216 is located near. The at least two dividing plates 220 can each be attached directly to inside wall 204, or can each be positioned within divider plate channel(s) 221 attached to inside wall 204.

In accordance with an embodiment, at least two of the cylindrical vessels 102 or 202 described above can be connected in series with the inlet of the second cylindrical vessel connected to the outlet of the first cylindrical vessel.

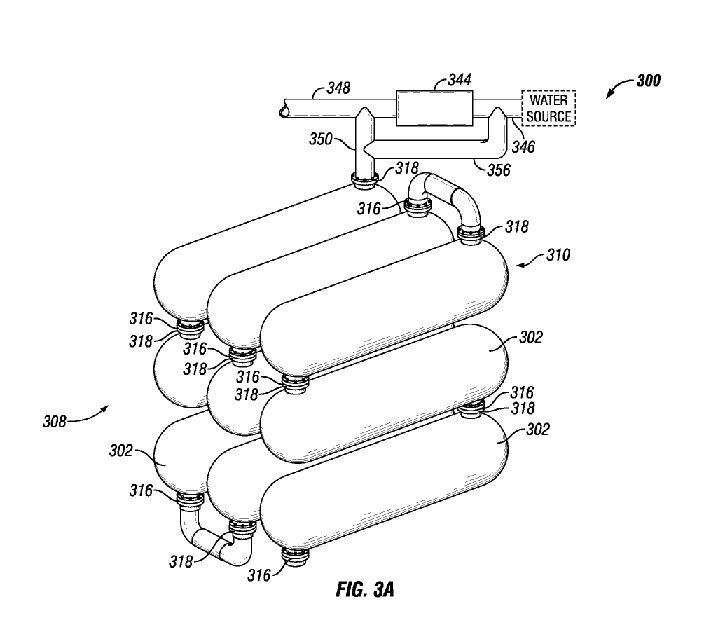

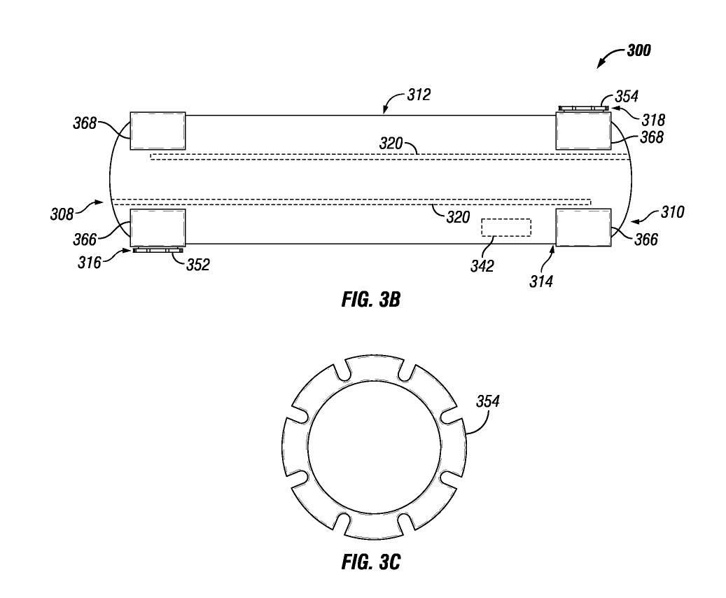

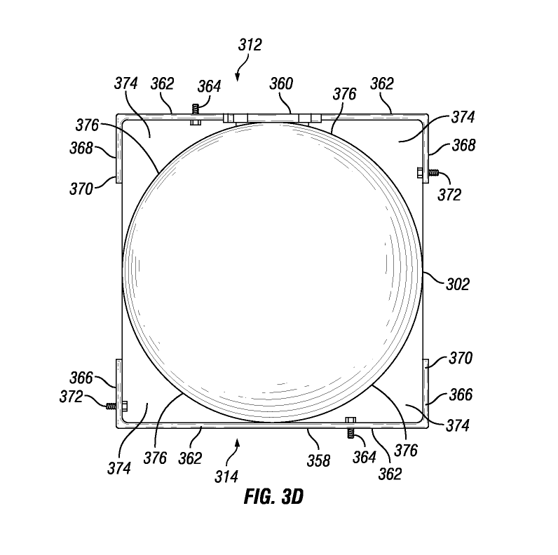

In accordance with an embodiment, and with reference to FIGS. 1A-1D, 2A-2C and 3A-3D, an apparatus 300 can comprise, consist of, or consist essentially of a plurality of any combination of the cylindrical vessels 102 and 202 as described above, and referred to in FIG. 3A as cylindrical vessel 302. The apparatus 300 can comprise n cylindrical vessels 302 in series, wherein n is at least 2. In accordance with this embodiment, the plurality of cylindrical vessels 302 can comprise at least one and at most one inlet 316. In accordance with an embodiment, for the 2nd and any subsequent cylindrical vessel 302, the at least one and at most one inlet 316 of the nth cylindrical vessel 302 is connected in fluid flow communication with the at least one and at most one outlet 318 of the n−1 cylindrical vessel 302. The at least one and at most one inlet 316 and the at least one and at most one outlet 318 for each of the plurality of cylindrical vessels 302 are centered to the vertical plane of the cylindrical vessel 302.

In accordance with an embodiment, and as shown in FIG. 3B which shows a single cylindrical vessel 302, the inlet 316 for each of the plurality of cylindrical vessels 302 comprises an inlet slotted flange 352 and the outlet 318 for each of the plurality of cylindrical vessels 302 comprises an outlet slotted flange 354, and the inlet slotted flange 352 of at least one of the plurality of cylindrical vessels 302 can connect to the outlet slotted flange 354 of the adjacent cylindrical vessel 302. FIG. 3C shows a top view of outlet slotted flange 354, and the inlet slotted flanges 352 have the same configuration as the outlet slotted flanges 354.

In accordance with an embodiment, the plurality of cylindrical vessels 302 can be arranged in vertical orientations (not shown). In accordance with an embodiment, the plurality of cylindrical vessels can be arranged in horizontal orientations, as shown in FIG. 3A.

In accordance with an embodiment, the apparatus 300 can comprise a dilution pump 344 having a pump inlet 346 and a pump outlet 348, and a cylindrical vessel outlet pipe 350 connected in fluid flow communication with the outlet 318 of the nth cylindrical vessel 302 and the pump outlet 348. A water source can also be connected in fluid flow communication with the pump inlet 346. As described above for the 100 and 200 apparatus, cylindrical vessels 302 each comprise at least one baffle 320. A mix element 342 can also be located within at least one of the plurality of cylindrical vessels 302 (shown in FIG. 3B) or the cylindrical vessel outlet pipe 350 (not shown). A diversion pipe 356 can also be connected in fluid flow communication with the cylindrical vessel outlet pipe 350 and the pump inlet 346 for diversion of fluid from the outlet 318 of the nth cylindrical vessel 302 to the pump inlet 346.

While FIGS. 3A-3B show the inlets 316 and outlets 318 at opposite ends of the cylindrical vessel 302, it is understood that the configuration can be the same as that shown in FIGS. 1A-1C wherein the inlet 116 and outlet 118 are at the same end of cylindrical vessel 102.

In accordance with an embodiment, as shown in FIGS. 3A and 3D (which shows a single cylindrical vessel 302 in end view), each of the plurality of cylindrical vessels 302 can further comprise a lower horizontal plate 358 connected to the bottom 314 and an upper horizontal plate 360 connected to the top 312 each located at both the first vessel end 308 and the second vessel end 310, wherein a lower horizontal plate 358 of at least one of the plurality of cylindrical vessels 302 is connectable to an upper horizontal plate 360 of the adjacent cylindrical vessel 302. Each of the upper horizontal plates 360 and lower horizontal plates 358 can comprise at least one slot or hole 362 positioned to engage a slot or hole 362 of a vertically adjacent cylindrical vessel 302 through which a connector 364 such as a bolt can be passed to connect the two vertically adjacent cylindrical vessels 302.

In accordance with an embodiment, inlet 316 can be aligned at or near the center of the lower horizontal plate 358 at the first end 308 or the second end 310, and the outlet 318 can be aligned at or near the center of the upper horizontal plate 360 at either the first end 308 or the second end 310. The vertically adjacent cylindrical vessels 302 can be connected by either or both of: a) the inlet slotted flange 352 of the upper cylindrical vessel 302 connected to the outlet slotted flange 354 of the lower cylindrical vessel 302, and b) the lower horizontal plate 358 of an upper cylindrical vessel 302 connected to the upper horizontal plate 360 of the lower cylindrical vessel 302.

In accordance with an embodiment, the lower horizontal plate 358 can comprise side members 366 at each end and extending perpendicular to and upward from the lower horizontal plate 358. In accordance with an embodiment, the upper horizontal plate 360 can comprise side members 368 at each end and extending perpendicular to and downward from the upper horizontal plate 360. Side members 366 and 368 are positioned on the outside of the cylindrical vessels 302. Each of the side members 366 and 368 can comprise at least one slot or hole 370 positioned to engage a slot or hole 370 of a horizontally adjacent cylindrical vessel 302 through which a connector 372 such as a bolt can be passed to connect the two horizontally adjacent cylindrical vessels 302. In accordance with an embodiment, each of the plurality of cylindrical vessels 302 can further comprise plates 374 connected to the outside wall 376, the lower horizontal plate 358, the upper horizontal plate 360, and the side members 366, respectively, as shown in FIG. 3D.

In accordance with an embodiment, and with reference to FIGS. 1A-1C, a method for hydrating a polymer can comprise, consist of or consist essentially of:

utilizing an apparatus as described above for apparatus 100;
introducing a slurry comprising water and the polymer to the cylindrical vessel 102 through the inlet 116; and
removing an at least partially hydrated polymer slurry from the outlet 118 of the cylindrical vessel 102.

In accordance with an embodiment, the at least one dividing plate creates a circuitous flow path for the slurry in the interior volume 106 of the cylindrical vessel 102 from the at least one inlet 116 to the at least one outlet 118. The flow of the slurry through the channels can be in plug flow. In accordance with an embodiment, water is charged to the pump inlet 146 and the at least partially hydrated polymer slurry is combined with, and diluted by, the water from the pump outlet 148 forming a diluted hydrated polymer stream. In accordance with an embodiment, at least a portion of the at least partially hydrated polymer slurry can be introduced to the pump inlet 146 through the diversion pipe 152.

In accordance with an embodiment, the slurry has an initial viscosity of from about 1 to about 5000 cP at 171 s⁻¹, or from about 1 to about 2000 cP at 171 s⁻¹ or from about 1 to about 1000 cP at 171 s⁻¹ or from about 1 to about 500 cP at 171 s⁻¹; and the pressure of the interior of the cylindrical vessel can be at least about 5 psia or from about atmospheric to about 15,000 psig or from about atmospheric to about 1,000 psig or from about atmospheric to about 700 psig.

In accordance with an embodiment, and with reference to FIG. 3A-3D, each cylindrical vessel 302 comprises at most one inlet 316 and at most one outlet 318, and a method for hydrating a polymer can comprise, consist of or consist essentially of:

utilizing an apparatus as described above for apparatus 300;
introducing a slurry comprising water and the polymer to a first cylindrical vessel 302 through the inlet 316;
removing an at least partially hydrated polymer slurry from the outlet 318 of the first cylindrical vessel 302;
for the 2nd and any subsequent of the cylindrical vessels 302:
introducing the at least partially hydrated polymer slurry to the inlet 316 of the nth cylindrical vessel 302; and
removing the at least partially hydrated polymer slurry from the outlet 318 of the nth cylindrical vessel 302.

Further, while the foregoing examples and figures describe continuous channels or fluid passageways which are formed within the chambers or interior of the enclosures with a dividing plate configuration, embodiments of the disclosure are not limited to only such designs, and it is well within the scope of the disclosure to have such channels or passageways constructed by any suitable design. Further, while it is general shown that apparatus of the disclosure include a port for receiving a mixture, and a port for discharging a slurry, mixture or product, some alternative embodiments may include ports on the periphery of the apparatus for various purposes, including, sampling, monitoring, controlling, injecting other materials into the mixture during movement through the apparatus, and the like.

Also within the scope of the disclosure are methods for treating at least a portion of a subterranean formation penetrated by a wellbore, which include introducing into one or more reaction vessels (such as those vessels and apparatus described herein) a mixture of a liquid component containing a first chemical reactant, and a second chemical reactant, and the mixture is passed through the at least one reaction vessel. A treatment fluid is then prepared and contains the mixture and an optional insoluble particle, and subsequently introduced into a wellbore.

Apparatus and methods of the disclosure may be useful in subterranean formation treatments where continuous mixing and hydration of well viscous treatment gels from dry polymer are required at a wellbore site, whether land based or offshore. However, the processes and apparatus may however be used for mixing other types of powder material with liquids as well. At a wellbore site once the well has been drilled and constructed and the drill rig removed, the site may be prepared for subterranean formation treatment or stimulation. The surface, or rig facilities and layout typically involve a number of pieces of mobile equipment including fracture fluid storage tanks, sand storage units, chemical trucks, blending equipment and pumping equipment. All facets of the hydraulic fracturing job from the blending and pumping of the fracture fluids and proppants—solid material, usually sand or other solid material, that is pumped into fractures to hold them open—to the way the rock formation responds to the fracturing, are often managed from a single control location. Apparatus of the disclosure may be a component of the blending equipment, and in fluid communication with pumping equipment. Integration of the apparatus and methods into the formation treatment equipment set up will be readily apparent to those of skill in the art having the benefit of this disclosure.

Lastly, in accordance with the disclosure, the hydratable polymer may be present at any suitable concentration in the mixture or produced slurry. In various embodiments hereof, the hydratable polymer can be present in an amount of from about 0.1 wt. % to about 10 wt. % of total weight of the mixture, from about 0.1 wt. % to about 7 wt. % of total weight of the mixture, from about 0.1 wt. % to about 5 wt. % of total weight of the mixture, from about 0.1 wt. % to about 4 wt. % of total weight of the mixture, from about 0.1 wt. % to about 3 wt. % total weight of the mixture, from about 0.1 wt. % to about 2 wt. % of total weight of the mixture, or even from about 0.1 wt. % to about 1 wt. % of total weight of the mixture.

The foregoing description of the embodiments has been provided for purposes of illustration and description. Example embodiments are provided so that this disclosure will be thorough, and will fully convey the scope to those who are skilled in the art. Numerous specific details are set forth such as examples of specific components, devices, and methods, to provide a thorough understanding of embodiments of the disclosure, but are not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,”, “top,”, “bottom,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although various embodiments have been described with respect to enabling disclosures, it is to be understood the invention is not limited to the disclosed embodiments. Variations and modifications that would occur to one of skill in the art upon reading the specification are also within the scope of the invention, which is defined in the appended claims.

What is claimed is:

1. A apparatus comprising:
a. a cylindrical vessel comprising an inside wall defining an interior volume, a first vessel end and a second vessel end, a top and a bottom;
b. at least one inlet in the bottom of the cylindrical vessel;
c. at least one and at most one outlet in the top of the cylindrical vessel; and
d. at least one dividing plate attached to the inside wall and disposed within the interior volume.

2. The apparatus of claim 1 wherein the cylindrical vessel has a vertical cylindrical vessel axis extending from the bottom to the top; wherein the at least one dividing plate comprises a first side, a second side, a first dividing plate end, a second dividing plate end, and a dividing plate surface extending from the first side to the second side; and wherein the first side and the second side are connected to the inside wall of the cylindrical vessel, the first dividing plate end is connected to the inside wall of the cylindrical vessel at either the first vessel end or the second vessel end, and the dividing plate surface is substantially perpendicular to the vertical cylindrical vessel axis.

3. The apparatus of claim 2 wherein the first dividing plate ends of the at least one dividing plate are connected to the cylindrical vessel alternatingly between the first vessel end and the second vessel end.

4. The apparatus of claim 1 wherein the at least one dividing plate and the inside wall form a plurality of channels, each channel having a channel cross sectional area and a hydraulic diameter HD such that the ratio of the HD to the maximum HD is greater than about 0.1 and less than or equal to about 1.0, wherein HD equals 4 times the channel cross sectional area divided by the wetted perimeter of the channel, and wherein the maximum HD is the HD of a circular channel formed by a circular pipe with a cross-sectional area equal to the channel cross sectional area.

5. The apparatus of claim 1 wherein the at least one inlet comprises an inlet slotted flange and the at least one and at most one outlet comprises an outlet slotted flange, and the inlet slotted flange is connectable to the outlet slotted flange of an adjacent cylindrical vessel.

6. The apparatus of claim 1 wherein the cylindrical vessel comprises at least one partition positioned substantially perpendicular to the at least one dividing plate and extending along the length of the cylindrical vessel.

7. The apparatus of claim 1 wherein the cylindrical vessel further comprises a mixing element in the interior volume.

8. An apparatus comprising:
a. a plurality of cylindrical vessels comprising n cylindrical vessels in series, wherein n is at least 2, and each of the plurality of cylindrical vessels comprises:
i) an inside wall defining an interior volume, a first vessel end and a second vessel end, a top and a bottom;
ii) at least one and at most one inlet in the bottom of the cylindrical vessel;
iii) at least one and at most one outlet in the top of the cylindrical vessel;
iv) at least one dividing plate attached to the inside wall and disposed within the interior volume; and
b. wherein, for the 2nd and any subsequent cylindrical vessel, the inlet of the nth cylindrical vessel is connected in fluid flow communication with the outlet of the n−1 cylindrical vessel.

9. The apparatus of claim 8 wherein the at least one and at most one inlet and the at least one and at most one outlet for each of the plurality of cylindrical vessels are centered to the vertical plane of the cylindrical vessel.

10. The apparatus of claim 8 wherein the at least one and at most one inlet for each of the plurality of cylindrical vessels comprises an inlet slotted flange and the at least one and at most one outlet for each of the plurality of cylindrical vessels comprises an outlet slotted flange, and the inlet slotted flange of at least one of the plurality of cylindrical vessels connects to the outlet slotted flange of the adjacent cylindrical vessel.

11. The apparatus of claim 8 further comprising a dilution pump having a pump inlet and a pump outlet, and a cylindrical vessel outlet pipe connected in fluid flow communication with the at least one and at most one outlet of the nth cylindrical vessel and the pump outlet.

12. The apparatus of claim 11 further comprising a mix element located within at least one of the plurality of cylindrical vessels or the cylindrical vessel outlet pipe.

13. The apparatus of claim 11 wherein a diversion pipe is connected in fluid flow communication with the cylindrical vessel outlet pipe and the pump inlet.

14. The apparatus of claim 8 wherein each of the plurality of cylindrical vessels further comprise a lower horizontal plate connected to the bottom and an upper horizontal plate connected to the top, each located at both the first vessel end and the second vessel end, wherein the lower horizontal plate of at least one of the plurality of cylindrical vessels is connectable to the upper horizontal plate of the adjacent cylindrical vessel.

15. A method for hydrating a polymer comprising:
a. utilizing an apparatus comprising:
i) a cylindrical vessel comprising an inside wall defining an interior volume, a first vessel end and a second vessel end, a top and a bottom;
ii) at least one inlet in the bottom of the cylindrical vessel;
iii) at least one outlet in the top of the cylindrical vessel;
iv) at least one dividing plate attached to the inside wall and disposed within the interior volume;
b. introducing a slurry comprising water and the polymer to the cylindrical vessel through the inlet; and
c. removing an at least partially hydrated polymer slurry from the outlet of the cylindrical vessel.

16. The method of claim 15 wherein the at least one dividing plate creates a circuitous flow path for the slurry in the interior volume of the cylindrical vessel from the at least one inlet to the at least one outlet.

17. The method of claim 15 wherein the apparatus further comprises a dilution pump having a pump inlet and a pump outlet, and a cylindrical vessel outlet pipe connected in fluid flow communication with the at least one outlet and the pump outlet; and wherein water is charged to the pump inlet and the at least partially hydrated polymer slurry is combined with, and diluted by, the water from the pump outlet forming a diluted hydrated polymer slurry.

18. The method of claim 17 wherein a diversion pipe is connected in fluid flow communication with the cylindrical vessel outlet pipe and the pump inlet; and wherein at least a portion of the at least partially hydrated polymer slurry is introduced to the pump inlet through the diversion pipe.

19. The method of claim 15 wherein the slurry has an initial viscosity of from about 1 to about 5000 cP at 171 s⁻¹ and the pressure of the interior of the cylindrical vessel is at least about 5 psia.

20. The method of claim 15 wherein the cylindrical vessel comprises at most one inlet and at most one outlet, and wherein the apparatus comprises a plurality of the cylindrical vessels comprising n cylindrical vessels in series, wherein n is at least 2; wherein, for the 2nd and any subsequent of the cylindrical vessels, the inlet of the nth cylindrical vessel is connected in fluid flow communication with the outlet of the n−1 cylindrical vessel; and
for the 2nd and any subsequent of the cylindrical vessels:
i) introducing the at least partially hydrated polymer slurry to the inlet of the nth cylindrical vessel; and
ii) removing the at least partially hydrated polymer slurry from the outlet of the nth cylindrical vessel.
